(19) United States
(12) Patent Application Publication
(10) Pub. No.: US 2003/0090789 A1
(43) Pub. Date: May 15, 2003

(54) Microscope comprising multifunctional control elements

(76) Inventors: Helge Herz, Neufahrn (DE); Georg Weiss, Jena (DE); Steffen Leidenbach, Gleichen (DE); Gunter Moehler, Jena (DE); Rolf-Gero Rau, Jena (DE); Frank Nolte, Dransfeld (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/221,088

(22) PCT Filed: Oct. 2, 2001
(86) PCT No.: PCT/EP01/11381

(30) Foreign Application Priority Data
Oct. 13, 2000 (DE) 100 51 299.2

(51) Int. Cl. G02B 21/00

(52) U.S. Cl. 359/368; 359/379; 359/383

(57) ABSTRACT

The invention is directed to a microscope with multifunctional operator controls for operating a plurality of electrically controlled components such as objective turret, filter turret, diaphragms, focus, illumination devices, and so on. Since the number of microscope functions to be controlled far exceeds the number of operator controls which can be operated in an ergonomic manner, one of the available microscope functions can be selectively assigned to every operator control. Further, functions of externally connected devices such as image recording cameras or manipulators can also be assigned to the operator controls of the microscope.

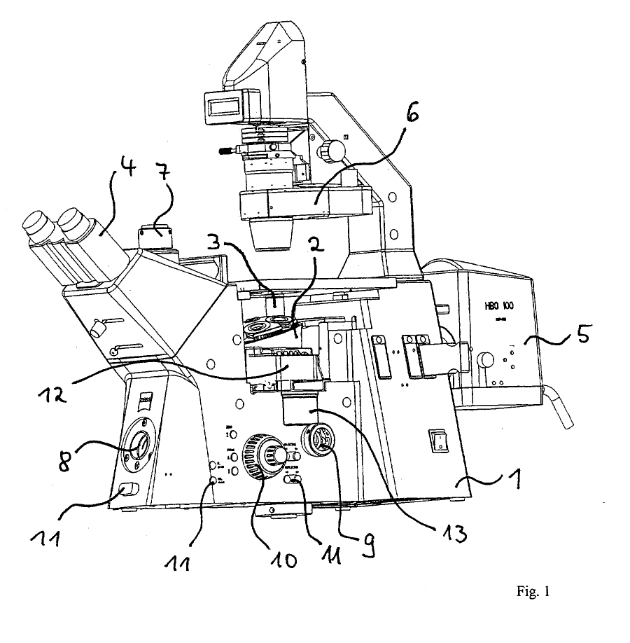

The invention is directed to a microscope, particularly a research microscope, which can be outfitted with a plurality of electrically controllable components such as focusing drive mechanism, specimen stage, objective turret, diverse filters and diaphragms, adjustable illumination devices, external image recording systems, and manipulators.

For operating components installed in the microscope stand, these microscopes have a plurality of operator controls such as buttons or rotating knobs. The manufacturers of the microscopes cause these operator controls to be arranged in the most ergonomic possible manner on the stand. This entails a number of problems. Since the user must operate the microscope while observing the specimen through the eyepieces, it should be possible to operate these operator controls “blindly”. Therefore, it must be ensured that there is sufficient distance between the buttons. On the other hand, as a result of the demand for easy operation, the buttons and rotating knobs are arranged in such a way that they can be operated without arm movement and their quantity is on the order of the number of fingers or, at most, two buttons are provided per finger. However, in a modern research microscope, the quantity of microscope functions substantially exceeds the quantity of operator controls which is limited by the above-mentioned demands. External components such as image capture systems, motor-actuated specimen stages and manipulators are usually outfitted with their own control units which, in turn, have the corresponding operator controls . Due to the fact that these control units must be set up separate from the microscope, their actuation entails considerable arm movements for the user. This is also true when the operator controls are located on the external components themselves because these components are usually arranged on or behind the microscope. It can also come about that the actuation of operator controls of external components is impeded by other components which are attached to the microscope and which conceal these operator controls or simply obstruct them.

A number of solutions are known to overcome the disadvantages mentioned above. For purposes of operating the microscope, U.S. Pat. No. 4,912,388 suggests the use of an external control device for the microscope. In order to reduce the quantity of necessary operator controls, this control device possesses the capability of assigning several functions to buttons by means of a switching button depending on the position of the switching button. This still suffers from the drawback that the control device is arranged separate from the microscope. Further, the number of microscope functions that can be actuated remains limited for the sake of maintaining ease of operation. DE-OS 196 37 756 discloses a multifunction operating unit for a microscope in the form of a computer mouse, the microscope functions being triggered by actuating different buttons on the mouse. Accordingly, the operator controls are assembled in a compact ergonomically shaped unit, but the problem of the limited quantity of operator controls is not solved.

It is known from EP 660 944 to assign different sensitively controlled functions, such as brightness regulation or aperture diaphragm control, to the focusing drive knob for each button actuation. A button is permanently associated with each function. Further, microscopes are known (Leica DMRXA and DMIRBE) in which it is possible to change the buttons for focusing and for the objective turret between a button arranged on the right-hand side of the microscope and a button arranged on the left-hand side of the microscope and to reverse the direction of the focusing drive mechanism by means of a command from an external control computer. This solution makes it possible to adapt the microscope to the user to a very limited extent, but does not simplify operation of the microscope in general.

Therefore, it is the object of the invention to overcome the disadvantages of the prior art and to simplify the operation of electrically controllable or motorized microscopes.

This object is met in a microscope with multifunctional operator controls according to the preamble of the first claim by the characterizing features of claim 1.

Advantageous embodiment forms according to the invention consist in that the assignment of the operator controls to the microscope functions is implemented in the control unit of the microscope. However, this can also be implemented in analogous fashion in an external control device which exchanges data with the microscope in a manner known per se.

The assignment of the operator controls to the microscope functions can be changed by actuating the operator controls in a defined manner or by means of the external control device.

Further, it is advantageous to make the current assignment of the operator controls visible to the user. This can be carried out by displaying on the operator controls themselves, by superimposing onto the visual field of the eyepiece of the user or by script on the microscope stand in the vicinity of the operator control.

The connection between the operator controls and the controls for the microscope components can advantageously be provided by an allocation table which can be provided in the control unit of the microscope or in the external control device.

In a method, according to the invention, for controlling microscopes, any desired controllable functions of the microscope or connected peripheral equipment are assigned to the operator controls.

In particular, the image recording function of a connected image recording camera is advantageously assigned to one of the operator controls of the microscope.

The invention will be described more fully in the following.

Modern research microscopes have a range of motorized components such as turrets for objectives, reflectors, filters, diaphragms, condensers, slides, optical light path switches and shutters. These motor-actuated components are controlled by one or more control computers installed in the microscope, whose program is generally stored as firmware in the EPROM. The user controls the microscope by means of operator controls such as buttons or handwheels which are electrically connected with the control computer. Functions such as changing objectives, incident light illumination, on/off, and so on,. were formerly permanently assigned to the buttons. These buttons or handwheels can be attached to the stand or assembled in external control devices (usually referred to as control panels). The microscope functions are implemented by calling up subroutines (functions) contained in the firmware of the control computer.

In modern microscopes, this controlling is also implemented by means of a connected personal computer which is connected to the microscope, e.g., by a serial data line. The operator controls are usually shown only on the display of the computer and are operated by means of a mouse or keyboard. Other peripheral devices such as cameras and manipulators are also operated either from special control panels or from the connected personal computer.

In the solution according to the invention, any function from the list of microscope functions available in the firmware or functions of the connected peripheral devices can be assigned to the operator controls of the microscope. This assignment can be implemented in a manner known per se, for example, by a branch table which is provided in the firmware and in which a number associated with every operator control acts as an index and the entry address of the firmware of the selected function is entered in the respective table entry. For assigning functions to external peripheral devices, the actuation of the operator control can be interrogated via the data line by the control device assigned to the peripheral devices and the corresponding functions are activated in an analogous manner.

Alternatively, it is also possible that the information is sent to the control device assigned to the peripheral devices without needing to call up the information in that the control computer installed in the microscope actuates a operator control.

An embodiment example of a microscope according to the invention is shown in the drawing.

A motor-actuated objective nosepiece (2) with objective (only one objective in this case) (3), an eyepiece (4), a motor-actuated reflector turret (12), an adjustable illumination device (5) and a motor-actuated condenser (6) are arranged on the microscope stand (1). The stand has a plurality of photographic outputs (7, 8, 9) whose light paths can be switched by means of motor-actuated light path switching devices (mirrors, prisms), not shown in the drawing. Further, the stand has a focusing drive knob (10) and a quantity of control buttons (11) which are arranged in an ergonomic manner in the vicinity of the focusing drive knob. The focusing drive mechanism (13) is motor-actuated by means of the focusing drive knob (10) through a control computer (not shown) which is installed in the microscope stand (1). In a manner, known per se, the microscope control computer has an arithmetic unit, an EPROM which contains the program for controlling the microscope and its components, and a RAM in which variable data for the control program are kept. For controlling the motor-actuated components, the control program (also referred to as firmware hereinafter) contains program sections (subroutines) which are assigned to the respective components and which have defined entry addresses (A1 . . . An). An index (Il . . . Im) is assigned to each operator control in the program. A branch table which is located in the RAM and which links the index of the operator control to the entry address of the respective assigned component serves to implement the desired assignment of the operator controls to the components. The program run can be described in a highly simplified manner as follows:

1. User actuates button x.

2. Program determines index of button: Ix.

3. Program searches in the branch table for the entry address Ay at location Ix.

4. Program executes the program at position Ay for controlling component y.

The initialization of the branch table, i.e., the assignment of the component functions to the buttons, can be achieved in different ways. Generally, a standard assignment of the buttons is stored in the firmware of the microscope control computer and is loaded as initial state in the branch table when the microscope is switched on. The table can be changed, i.e., another function can be allotted to a button or to the focusing drive knob, e.g., by a connected control device (e.g., personal computer) which sends corresponding firmware commands to the firmware of the microscope control computer, e.g., “load table entry x with the entry address of component y”. Alternatively, firmware can also be implemented by means of which the assignment of the operator controls to the microscope functions is carried out by actuating buttons in special sequences.

When the microscope has a connected control device, the assignment of the operator controls to the microscope functions can also be implemented in this control device. The branch table is then located in the control device and the corresponding program run can be described in a highly simplified manner as follows:

1. User actuates button x.

2. Firmware determines index of button: Ix and sends it to the control device via a data line.

3. Program in the control device searches in the branch table for the branch address: Ay at position Ix.

4. Program executes the program at point Ay which sends the corresponding firmware command to the microscope for controlling component y.

5. Firmware of the microscope interprets this command and controls the corresponding component.

When peripheral devices such as cameras or manipulators are connected to the microscope, these peripheral devices usually have their own software for controlling the corresponding functions (image recording, etc.) which can be called up by a subordinate program for triggering the function. When these functions are to be triggered by the operator controls of the microscope, the program runs as follows:

1. User actuates button x.

2. Firmware determines index of button: Ix and sends it to the control device via the data line.

3. Program in the control device searches in the branch table for the branch address: Ay at location Ix.

4. Program executes the program at point Ay which calls up the corresponding function of the peripheral device.

5. The software of the peripheral device executes the corresponding function.

This solution is particularly advantageous when frequently recurring functions such as the image recording of a connected camera can be triggered by an operator button of the microscope.

The invention is not limited to the embodiment example shown herein. In particular, other possibilities for implementing the assignment of the operator controls to the functions other than the branch table shown herein are also possible.

1. Microscope with multifunctional operator controls, comprising a microscope stand having electrically controllable components such as objective turret, light source and condenser which are electrically controlled by a control unit, and operator controls for this electrical controlling, characterized in that any desired electrically controlled microscope function, especially of these microscope components, can be assigned to the operator controls by a suitable connection between the operator controls and the controlling:

2. Microscope with multifunctional operator controls according to claim 1, characterized in that this assignment can be implemented in the control unit.

3. Microscope with multifunctional operator controls according to claim 1, characterized in that this assignment can be implemented in an external control device which exchanges data with the microscope control unit in a manner known per se.

4. Microscope with multifunctional operator controls according to claim 1, characterized in that the assignment of the operator controls can be changed by actuating the operator controls in a defined manner.

5. Microscope with multifunctional operator controls according to claim 1, characterized in that the assignment of the operator controls can be changed by the external control device.

6. Microscope with multifunctional operator controls according to claim 1, characterized in that the microscope functions can also comprise functions of externally connected components such as cameras, specimen stages or manipulation devices.

7. Microscope with multifunctional operator controls according to claim 1, characterized in that the current assignment of the operator controls is visible.

8. Microscope with multifunctional operator controls according to claim 6, characterized in that the current assignment of the operator controls can be displayed on the operator controls.

9. Microscope with multifunctional operator controls according to claim 6, characterized in that the current assignment of the operator controls can be superimposed in the viewing field of a user.

10. Microscope with multifunctional operator controls according to claim 6, characterized in that the current assignment of the operator controls can be displayed in the vicinity of the operator controls on the microscope stand.

11. Microscope with multifunctional operator controls according to one of the preceding claims, characterized in that the connection is implemented by means of an allocation table in the control unit or in the control device, which allocation table connects the operator controls with the controlling.

12. Method for controlling a microscope, preferably according to one of the preceding claims, characterized in that any desired function of an electrically controllable microscope component is assigned to an operator control of the microscope.

13. Method for controlling a microscope, preferably according to one of the preceding claims, characterized in that any desired function of an electrically controllable external device which is electrically connected to the microscope is assigned to an operator control of the microscope.

14. Method for controlling a microscope, preferably according to one of the preceding claims, characterized in that a function for image recording of a connected image recording camera is assigned to an operator control of the microscope.
